(19) United States
(12) Patent Application Publication
(10) Pub. No.: US 2015/0334799 A1
(43) Pub. Date: Nov. 19, 2015

(54) MULTIPLE BACKLIGHT KEYBOARD

(71) Applicant: Apple Inc., Cupertino, CA (US)

(72) Inventors: Alejandro Lara ASCORRA, Gilbert, AZ (US); Adam I. PAPAMARCOS, San Francisco, CA (US); Asif HUSSAIN, San Jose, CA (US); Mohammad J. NAVABI-SHIRAZI, San Jose, CA (US); Keith J. HENDREN, San Francisco, CA (US); Thai Q. LA, San Jose, CA (US)

(73) Assignee: Apple Inc., Cupertino, CA (US)

(21) Appl. No.: 14/279,191

(22) Filed: May 15, 2014

(51) Int. Cl. H05B 33/08; H01H 13/83

(52) U.S. Cl. CPC H05B 33/0845; H01H 13/83; H05B 33/0863; H01H 2219/039

(57) ABSTRACT

This application relates to a dynamic lighting circuit for a keyboard of a computing device. The lighting circuit described herein includes several light emitting diode (LED) drivers having multiple channels for controlling multiple LEDs. The lighting circuit also includes an electrically erasable read-only memory (EEPROM) for storing configuration data for the LED drivers. Each LED is configured to individually illuminate a single key of the keyboard, allowing the lighting circuit to modify the brightness of each key without affecting the brightness of other keys. In this way, more lighting schemes are available for the keyboard, while also providing a thinner mechanical design for the keyboard. Lighting schemes can include illuminating a group or groups of keys at a different brightness level than other keys that are not contained in the group. Additionally, lighting schemes can include animations executed by varying the brightness levels of keys over a period of time.

### FIELD

The described embodiments relate generally to keyboard backlights. More particularly, the described embodiments relate to a keyboard circuit for individually illuminating keys of a keyboard using multiple keyboard backlights.

### BACKGROUND

Computers have become more user-friendly with the advancement of technology. Many computing devices are designed to provide an intuitive user interface that is less taxing on the user. For example, many user interfaces can now learn and adapt to the inputs of a user over the lifetime of the computer. Although these technologies can improve the efficiency a particular computer, they may fall short when the hardware of the computer does not provide a dynamic interface for relaying information to the user. For instance, the introduction of touch screens has provided an added level of dynamics for computers that could not have been provided if users were still limited to a mouse and keyboard configuration. Touch screens are dynamic in their ability to adjust and present a user with an almost infinite number of interfaces for interacting with a computer. Conversely, a keyboard is an example of a particular piece of hardware that has continually lacked dynamics. Despite computers becoming more useful for a variety of personal, business, and manufacturing tasks, keyboards have hardly changed beyond their original design. Physically, some keyboards have improved by providing a single backlight that allows the user to see the keys of a keyboard better. However, such backlights are typically static and therefore do not provide any additional utility beyond improving the visibility of keys.

### SUMMARY

This paper describes various embodiments that relate to multiple keyboard backlights. In particular, some embodiments set forth herein include a lighting circuit for a keyboard. The lighting circuit can include a plurality of light emitting diode (LED) drivers. Additionally, the lighting circuit can include a host controller connected to the plurality of LED drivers, and a memory connected to the host controller, which can store configuration data for the plurality of LED drivers. Furthermore, the lighting circuit can include a plurality of LEDs connected to the plurality of LED drivers, wherein each LED of the plurality of LEDs are assigned to illuminate a key of the keyboard and each LED is capable of being individually responsive to an operation performed by a computing device associated with the keyboard.

In some embodiments, a method is set forth for controlling brightness of light emitting diodes (LEDs) connected to a keyboard. The method can include sending a command to a lighting circuit for a keyboard, wherein the lighting circuit controls the brightness of a plurality of LEDs. The method can further include a step of causing the brightness of one or more LEDs of the plurality of LEDs to change.

In other embodiments, a machine-readable non-transitory storage medium is set forth for controlling a plurality of LEDs. The storage medium can store instructions that, when executed by a processor included in a computing device, cause the computing device to carry out steps that include: sending a command to modify a plurality of LEDs based on a predetermined configuration. Each LED of the plurality of LEDs can be configured to individually illuminate a key of a keyboard. The instructions can further include a step of causing the brightness of one or more LEDs of a plurality of LEDs to change according to the predetermined configuration.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A-1B illustrate a perspective view of a computing device and interior of a keyboard according to some embodiments described herein;

FIG. 2 illustrates a perspective view of the interior of a keyboard having light emitting diodes (LEDs) configured inside according to some embodiments described herein;

FIG. 3 illustrates an embodiment of the keyboard having multiple LEDs per key according to some embodiments described herein;

FIG. 4 illustrates a flow diagram of a circuit for controlling the keyboard LEDs according to some embodiments described herein;

FIG. 5 illustrates the calibration of the keyboard of the computing device according to some embodiments described herein;

FIG. 6-8B illustrates an embodiment of the keyboard having multiple LEDs wherein only certain keys are illuminated based on software functions of the computing device according to some embodiments described herein;

FIG. 9 illustrates a method for operating a keyboard having multiple backlights;

FIG. 10 illustrates a method for calibrating a keyboard having multiple backlights;

FIG. 11 illustrates a method for modifying the brightness level of one or more LEDs of a keyboard according to some embodiments described herein;

FIG. 12 illustrates a method for modifying the brightness level of one or more LEDs of a keyboard according media data associated with a media file; and

FIG. 13 illustrates a method for modifying the brightness level of one or more LEDs of a keyboard according an expected command from a user of the keyboard.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The user experience for various computing devices has been drastically changing over time. Many advances in technology have led to computer interfaces that are more intuitive for a user, thereby allowing the user to more effectively use the computing device. For example, computer keyboards have become easier for the user to accomplish various tasks such as word processing and web browsing. In particular, lighting schemes for computing devices have provided a user with more visibility when typing. However, many lighting schemes lack dynamics and variability even though the computing device may otherwise contain many powerful and dynamic software applications. The embodiments set forth herein provide a more dynamic lighting circuit for a keyboard of a computing device in order to cure the aforementioned deficiencies. The lighting circuit described herein includes several light emitting diode (LED) drivers having multiple channels for controlling multiple LEDs. The lighting circuit also includes an electrically erasable read-only memory (EEPROM) for storing configuration data for the LED drivers. Each LED is configured to individually illuminate a single key of a keyboard, allowing the lighting circuit to modify the brightness of each key without affecting the brightness of other keys. Not only does this provide more possibilities for lighting schemes for the keyboard, but this also provides a thinner mechanical design for the keyboard as the LEDs can be located more proximate to the individual keys. Lighting schemes can include illuminating a group or groups of keys at a different brightness level than other keys not contained in the group. For example, if the user is playing a game or using a software application that uses one or more keys more frequently than other keys, the more frequently used keys can be illuminated while the other keys can remain dim or off. Additionally, by providing a lighting circuit with such capabilities, a uniform brightness for the entire keyboard can be established through an initial calibration process, as discussed further herein. The calibration process ensures that the entire keyboard is evenly illuminated to give a naturally uniform brightness across the keyboard.

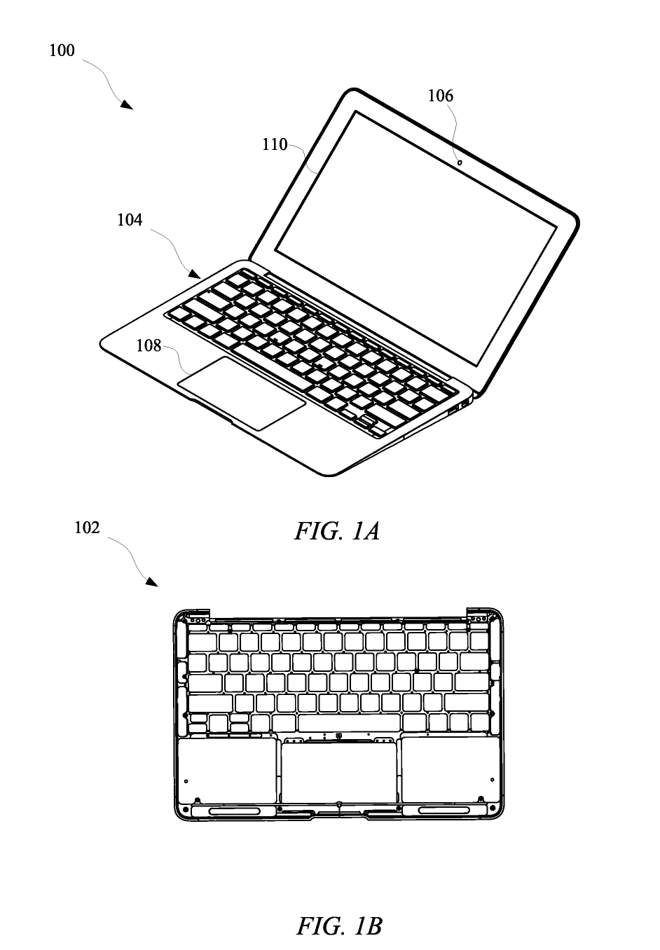

These and other embodiments are discussed below with reference to FIGS. 1-13; however, those skilled in the art will readily appreciate that the detailed description given herein with respect to these figures is for explanatory purposes only and should not be construed as limiting.

FIG. 1A illustrates a perspective view of a computing device 100. Specifically, FIG. 1A shows a computing device 100 having a keyboard 104, camera 106, touchpad 108, and display 110. An interior view of the keyboard is provided in FIG. 1B. When operating the computing device 100, it may be desirable to have a certain amount of illumination provided for a user of the computing device 100. The illumination can be provided from the display 110 in order to illuminate the keyboard 104 and touchpad 108. The illumination can also be provided from the camera 106, which can include an internal light source for creating better quality movies or taking pictures. The lighting can also be provided from a backlight located at the interior 102 of the keyboard 104. However, having a single backlight may not be adequate for a user of the computing device 100. Additionally, the backlight may conflict with the lighting of the display 110 and the internal light source of the camera 106. Moreover, incorporating only a single backlight limits the operability of the keyboard 104 by not providing a user with a more dynamic set of keyboard lights. However, the embodiments set forth herein are intended to resolve these aforementioned issues by providing a more dynamic means for lighting a keyboard. By incorporating multiple lights that are dynamically operated by the computing device 100, a user is provided with a keyboard interface that can adjust for various tasks and functions of the computing device 100. In this way, the user is able to be more efficient because the keyboard interface offers an additional means for communicating information to the user.

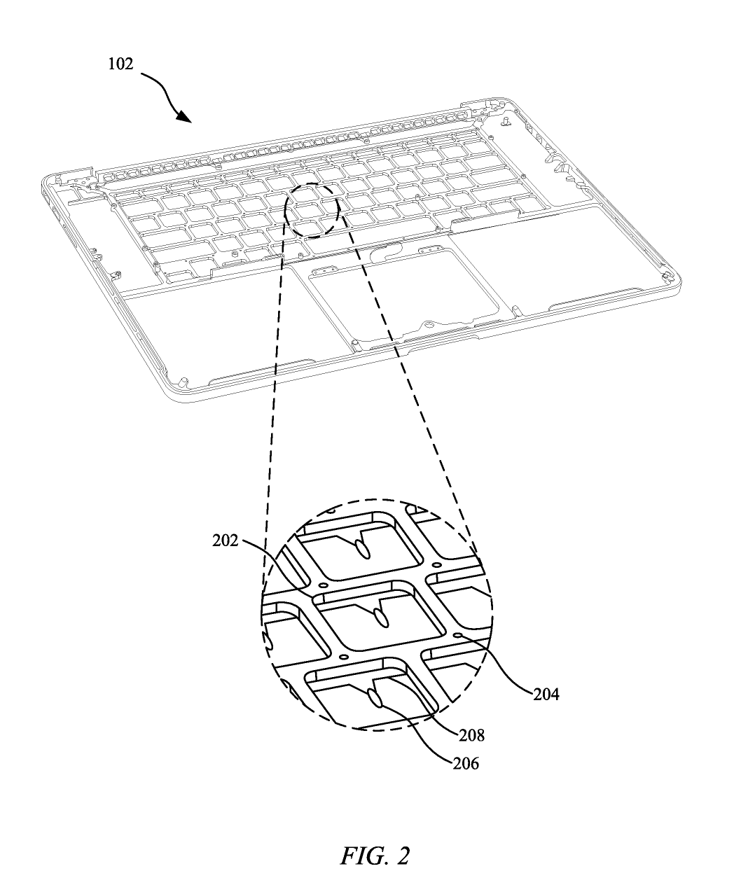

FIG. 2 illustrates a perspective view of the interior 102 of the keyboard 104. Specifically, FIG. 2 sets forth an arrangement of light emitting diodes (LEDs) 206 within the interior 102 of the keyboard 104. In some embodiments, the LEDs 206 are connected to a wire 208, or flexible cable 208, or multiple flexible cables 208 that form cable rows across the interior 102 of the keyboard 104. The flexible cables 208 can extend from a circuit that drives the LEDs 206. The flexible cables 208 can extend from a lateral portion of the interior 102 and reside above or below the interior 102 of the keys of the keyboard 104. In this way, the LEDs 206 can branch off of a flexible cable 208 in a respective row of keys and terminate within a cavity 202 of the interior 102. The LEDs 206 can also be configured to terminate above or below the lateral edges of the cavities 202, or within apertures 204 of the interior 102. Moreover, the LEDs 206 can terminate within the portion of the key that is typically depressed by a user. For example, the space bar of the keyboard 104 can include one or more LEDs 206 that are within the volume of the portion of the space bar that depressed by a user. In some embodiments, the LEDs 206 branch off from the keyboard 104 away from or toward the display 110. In some embodiments, the flexible cable 208 extends through the interior 102 substantially perpendicular or parallel to the display. The flexible cable 208 can also be embedded into a housing of the computing device 100 during one or more manufacturing processes. In this way, the cable providing the power and control signals to the LEDs 206 and/or the LEDs 206 is completely encapsulated by the material that forms the housing of the computing device 100.

The keys of the keyboard 104 can be configured within the computing device 100 such that light from the LEDs 206 can escape the keyboard 104. For example, in some embodiments, the keys are separated from a surface portion of the keyboard 104 to reveal the LEDs 206. Moreover, in some embodiments, the keys can include apertures angled perimeters that allow light from the LEDs 206 to escape from the keys. The keys can also be translucent or transparent in some embodiments. Additionally, as discussed further herein, the keys can include multiple LEDs 206. In this way, each key can be assigned one or more LEDs 206 that can illuminate the key or a portion of the key during operation of the computing device 100.

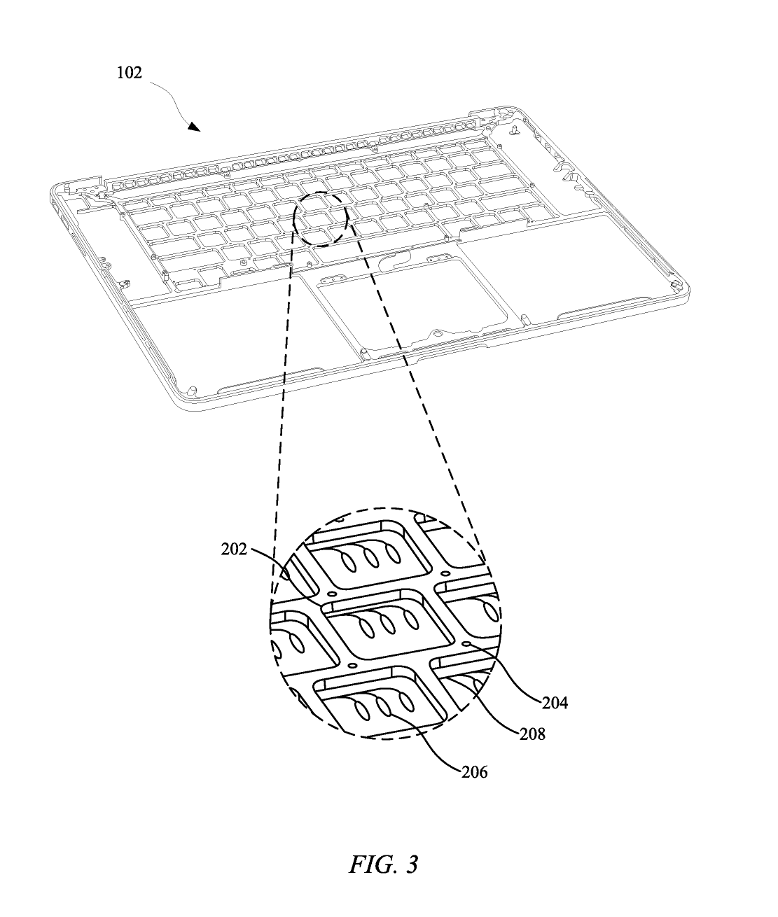

FIG. 3 illustrates an embodiment of the keyboard 104 having multiple LEDs 206 per key. Similar to FIG. 2, the interior 102 of the keyboard 104 can include flexible cables 208 that form rows across the interior 102. In some embodiments, the keyboard 104 can include six rows of flexible cables 208 for providing power and control signals to the LEDs 206. In other embodiments, more or less than six rows can be used. The LEDs 206 of FIG. 2 can be a variety of types of LEDs 206. For example, in some embodiments, each cavity 202 or aperture 204 can be assigned one or more single color LEDs 206 such as a red, green, blue, white, etc., colored LED. In other embodiments, each of the LEDs 206 is a bi-color or a tri-color LED. Moreover, the number of LEDs 206 per key or cavity 202 can be at least one or more LEDs 206, and each key or cavity 202 can be assigned a variety of types of LEDs 206. For example, a cavity 202 can be configured to include a single color LED, a bi-color LED, and/or a tri-color LED, or any suitable combination thereof.

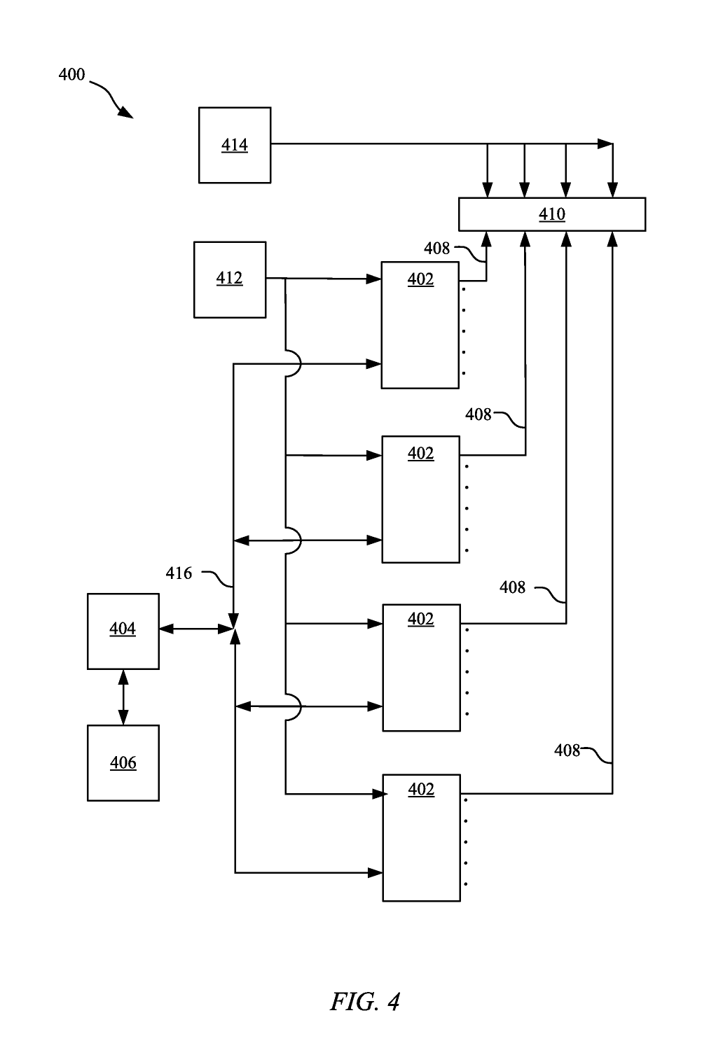

FIG. 4 illustrates a flow diagram of a circuit 400 for controlling the keyboard backlights. Specifically, FIG. 4 shows how the LEDs 206 of the keyboard 104 are powered and controlled by a circuit 400 of the computing device 100. The LEDs 206 are represented as an LED matrix 410 in FIG. 4. The LED matrix 410 represents every key at the keyboard 104 that is receiving an LED 206, and includes all the conductive pathways that transmit power and control signals to the LEDs 206. The LED matrix 410 can receive supply power 414 from the computing device 100 in a variety of voltages not limited to 5 volts or 3.3 volts at approximately 15 milliamps per LED 206. Moreover, in some embodiments, the voltage can be greater than or less than 3.3 volts, and the current can be greater than or less than 15 milliamps per LED 206. The supply power 414 can be a single line boost supply that allows for the beaming up and down of all the LEDs 206 of the LED matrix 410 at one time. The control signals 408 are received by the LED matrix 410 from one or more backlight drivers 402. The backlight drivers 402 can include 16 channels for outputting control signals 408 to the LED matrix 410. Therefore, by incorporating multiple backlight drivers 402, the number of LEDs 206 in the LED matrix 410 can be increased to accommodate a variety of LEDs 206. Specifically, in FIG. 4, four backlight drivers 402 are set forth thereby allowing the LED matrix 410 to include as many as 64 LEDs 206. For keyboards having over 100 keys, the number of backlight drivers 402 can be increased to 10 or more in order to supply control signals 408 to each of the LEDs 206. Moreover, as in FIG. 3 where multiple LEDs 206 are assigned to a single key of a keyboard 104, backlight drivers 402 can be provided to accommodate the number of LEDs 206 assigned to each individual key. For example, in some embodiments, each key of the keyboard 104 includes a red LED, a green LED, and a blue LED. Therefore, if a keyboard 104 contains over 100 keys and the circuit 400 included 16 channel backlight drivers 402, the circuit 400 would incorporate a total of at least 19 backlight drivers 402. Other backlight drivers 402 can be used in other embodiments to accomplish a variety of LED 206 combinations and configurations. For example, in some embodiments, the backlight drivers 402 can include 8-channels, 10-channels, 16-channels, 32-channels, or any suitable number of channels, or any suitable combination thereof. Moreover, the circuit 400 can incorporate a high density ball grid array (BGA) to allow for ease of manufacturing and assembly of the circuit 400, especially with respect to the LED matrix 410, which can include over 100 control signals 408 and supply power 414 connections. In this way, the BGA can provide a more organized interface for permanently soldering or otherwise connecting the various components of circuit 400.

The circuit 400 can further include a host controller and an electrically erasable read-only memory (EEPROM) 406. The EEPROM 406 can be configured to store default settings, device configuration, calibration settings, or any other data for initiating and running the circuit 400. For example, the EEPROM 406 can include firmware for configuring the circuit 400. The firmware can be loaded into the host controller 404 and configure the backlight drivers 402 during a startup procedure of the computing device 100. Additionally, the EEPROM 406 can be read-only or rewritable. In the embodiments where the EEPROM 406 is rewritable, the EEPROM 406 can be upgraded or otherwise modified by a user or a manufacturer. For example, the computing device 100 can receive updates from the internet that include firmware updates, which can be loaded into the EEPROM 406 by the host controller 404. The host controller 404 can be a hardware device on the main logic board of the computing device 100 that interacts with a software driver stored in a memory of the computing device 100. In this way, the host controller 404 can use a digital connection 416 between the host controller 404 and the backlight drivers 402 to control the LED matrix 410.

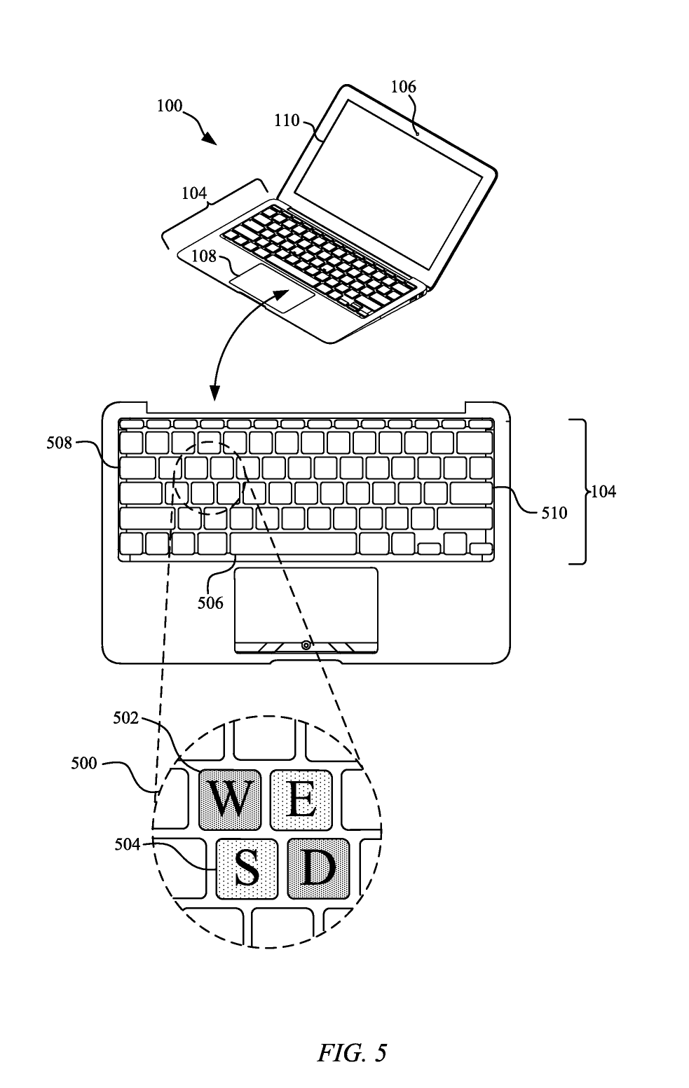

FIG. 5 illustrates the calibration of a keyboard 104 of a computing device 100 according to some embodiments described herein. In particular, FIG. 5 illustrates how individual LEDs 206 of the keys of keyboard 104 are calibrated in order that the entire keyboard can have a uniform brightness during certain operations of the computing device 100. Because each key of the keyboard 104 can be configured out of various materials and have a variety of dimensions, the light emitting from LEDs 206 assigned to each key can in some instances can be disrupted by certain features of each key. For example, the space bar 506 can have allow more or less light to escape from the LEDs 206 that are assigned to the space bar 506 than other LEDs 206 that are assigned to other keys, such as the “W” key 502 and “S” key 504. Moreover, in some embodiments, the “W” of the “W” key 502 can configured to be more translucent than the “S” of the “S” key 504. Therefore light emitting from LEDs 206 assigned to each key respectively will emit a different amount of light. This difference in the amount of light emitted, typically measured in nits, can be noticeable by a user of the keyboard 104. A calibration process that provides a more uniform brightness among all the keys of the keyboard 104 is provided herein to resolve the aforementioned issues.

The calibration process can include an external camera, ambient light sensor, or camera 106 of the device, and can occur prior to manufacturing, during manufacturing, or after manufacturing. During the calibration process, the external camera (or camera 106) can record a total nits value for the entire keyboard 104 at one or more levels of brightness. For example, in some embodiments, a calibration process is performed for each step of brightness (e.g., 256 steps in some embodiments) so that the keyboard 104 can be uniform for all levels of brightness. The total nits for each level of brightness of the keyboard 104 can be compared to a predetermined nits value for the total nits that a user or manufacturer has established for performance, aesthetics, or efficiency purposes. In some embodiments the predetermined nits value is based on a natural resolution that is desired for the keyboard 104 when the entire LED matrix 410 is illuminated. Additionally, the total nits for each level of brightness of the keyboard 104 can be compared to a predetermined nits value that provides a linear transition from a low level of brightness to a maximum level of brightness. If the total nits measured is not equivalent to the predetermined nits value, the calibration process proceeds to a step of recording the individual nits value for each key on the keyboard at a particular level of brightness. The key having the highest or lowest nits value can be modified to receive a reduced or increased current thereby adjusting the amount of light emitted from the LED 206 associated with the key. If multiple keys share the highest or lowest nits value then one or more of the keys can receive the reduced or increased current. The calibration process can then proceed to the previous step of recording a total nits value for the entire keyboard 104 and comparing the total nits value to the predetermined nits value. If the total nits value is not equivalent to the predetermined nits value, the calibration process will proceed to the step of recording the individual nits value for each key on the keyboard and modifying the nits value for the key of the keyboard 104 having the highest or lowest nits value. The calibration process can terminate when the total nits value is equivalent to the predetermined nits value. Moreover, the calibration process can be repeated for multiple levels of brightness of the keyboard 104. For example, the calibration can be repeated until a transition or step between the total nits of the keyboard 104 at the lowest level of brightness to the highest level of brightness is substantially linear.

In some embodiments the calibration process is based on a measurement of nits during an animation displayed by the entire LED matrix 410 or a portion of the LED matrix 410 of the keyboard. For example, LED matrix 410 can be configured to project a wave-like progression of light starting from one end of the keyboard 104 to an opposing end of the keyboard 104. The increase and decrease of nits across the keyboard over a brief period of time can be measured and compared to a predetermined set of nits data. If the wave of light does not coincide with the predetermined set of nits data based on a measurement of the wave-like progression of light over a brief period of time (e.g., the time it takes for the wave of light to start and end), the calibration process will undergo the aforementioned calibration process. The calibration process can be modified for a variety of computing devices such as desktops computers, and wireless keyboards. The calibration process can also include multiple cameras located at a variety of angles or positions relative to the keyboard 104 that is being calibrated. Once calibrated, the desired calibration settings can be stored at the EEPROM 406 during manufacturing, or after manufacturing as an update (e.g., a firmware update).

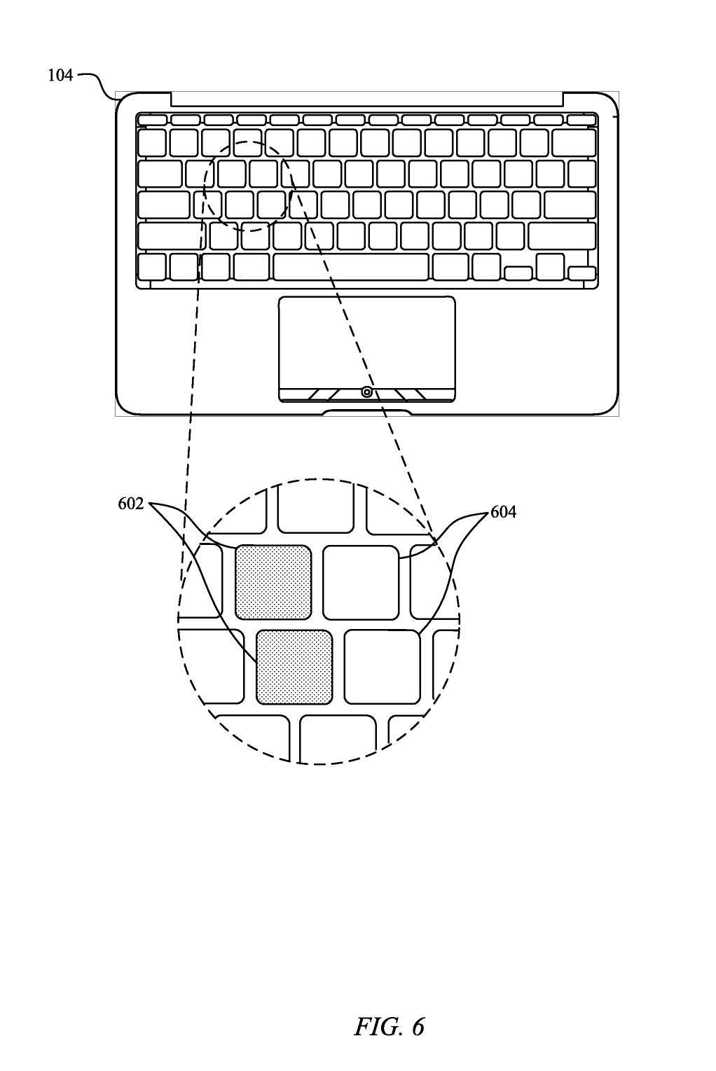

FIG. 6 illustrates an embodiment of a keyboard 104 having isolated backlights. Specifically, FIG. 6 illustrates a keyboard 104 having multiple backlights, with only some backlights illuminated. The computing device 100 can include multiple software applications ranging from word processing applications, game applications, internet applications, or any other suitable application desired by a user of a computing device 100. Some of these applications may use keys of the keyboard more often than other applications. For example, a game application that only uses an up and down command may only require the user to press two keys. Therefore, as illustrated in FIG. 6, when the user starts the game application the lighting circuit 400 can limit the amount of current going to the majority of the LEDs 206 on the keyboard 104. In this way, the illuminated keys 602 tell the user to only use the illuminated keys 602 and not the non-illuminated keys 604. The keyboard 104 can also react to the game being played by flashing some or all of the LEDs 206 at certain points during the game (e.g., the end of a level or when the user receives points). When the user stops playing the game application, minimizes the game application, or starts a new application, the illuminated keys 602 can either turn off, stay on, or adjust in brightness according to the operation being performed by the computing device 100.

FIG. 6 can also illustrate an embodiment wherein the user is prompted by software on the computing device 100 to hit a certain key. For example, during the operation of a word processing application, the user can be presented with a save window that prompts the user to save changes to a document or not to save changes to a document. When the save window opens, the keyboard 104 can present the illuminated keys 602 as key strokes for indicating that the user wants to save changes or does not want to save changes. The key strokes can be one ore more keys intended to be depressed at the same time or in a sequence. The non-illuminated keys 604 will remain off or at a lower brightness setting than the illuminated keys 602 until the user makes a selection or otherwise performs an operation unrelated to the word processing application. In some embodiments, the illuminated keys 602 are illuminated by operation of auto-fill software that attempts to predict the next key a user will be pressing. For example, if a user is spelling the name of a person listed in an address book stored on the computing device or the internet, the circuit 400 can cause the computing device 100 to search the address book for the first few letters that the user has already pressed on the keyboard and then highlight the remaining letters to be depressed in order to spell the name of the contact. For example, if the name of the user has typed “Bob” into a field in a software window and a contact name in the address name is “Bobby,” the circuit 400 can cause LEDs associated with the “B” and “Y” keys to become illuminated in expectation of what the user might be typing. In some embodiments, the LEDs 206 can be illuminated by the circuit 400 according to a spell-checking application. In this way, if a user spells a word wrong, the keys that would be used to correct the spelling error can be illuminated. For example, if the user writes “wynter,” the LED 206 associated with the “I” key of the keyboard 104 can be illuminated in expectation that the user was intending to spell “winter.” In this way, the user is provided with an additional means of being notified that a spelling error has occurred The keys that are illuminated during use of various software applications can be set by a user, a manufacturer of the computing device 100, or a manufacturer of the software application.

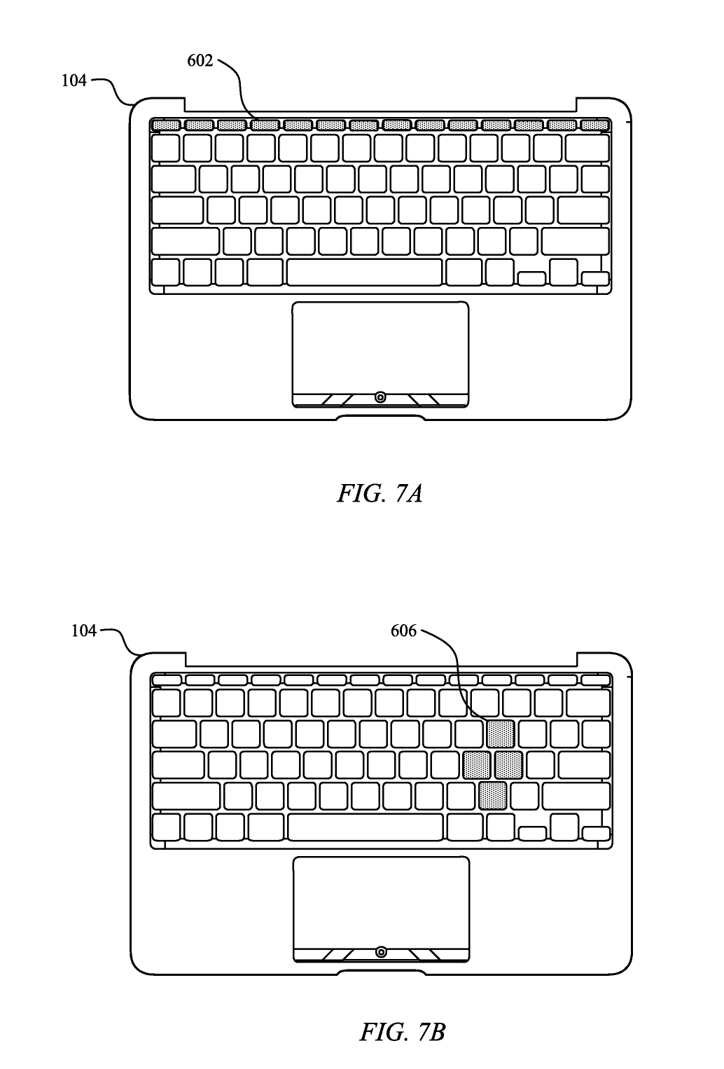

FIGS. 7A-7B illustrate embodiments of a keyboard 104 having multiple backlights where only certain keys have been set to be illuminated according to some embodiments herein. Specifically, FIG. 7A shows an embodiment wherein the keyboard 104 has been configured to only illuminate the illuminated keys 602. This embodiment can be setup by a user of the computing device 100 or by a manufacturer of the computing device. Moreover, this configuration for the illuminated keys 602 can be the result of a software application opening or performing a function that primarily uses the illuminated keys 602 for operations. In other embodiments, other groups of keys of the keyboard 104 can be illuminated. For example, in some embodiments, only the keys labeled with a single letter of the alphabet are illuminated. Additionally, as illustrated in FIG. 7B, when a user is browsing the internet only certain keys can be illuminated in order to optimize the browsing experience and enable the user to quickly move between web pages. For example, the keys that are illuminated in FIG. 7B can be browsing keys 606 that enable scrolling of web pages using the top and bottom keys of the browsing keys 606, and moving back and forth in the browsing history by using the left and right keys of the browsing keys 606. In some embodiments, when a user moves a cursor into the address bar of the internet browsing window, the keys that are not illuminated (e.g., other alphanumeric keys) can become illuminated in order to emphasize that an alphanumeric input is expected from a user.

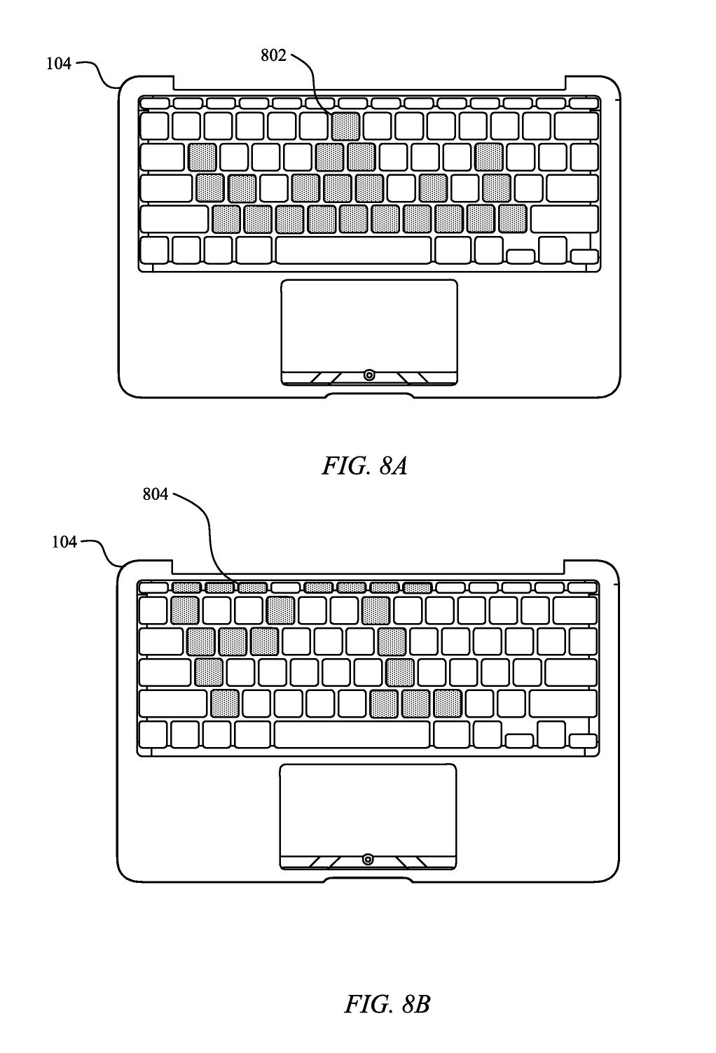

FIGS. 8A-8B illustrate embodiments of a keyboard 104 having multiple backlights wherein only certain keys have been set to be illuminated according to some embodiments described herein. Specifically, FIG. 8A shows an embodiment wherein the keyboard 104 has been configured to be modified dynamically by software running on the computing device 100 or by a user input. For example, in some embodiments the computing device includes media player software that can play music, movies, and other media files. As a media file plays, the computing device 100 can output audio or display images associated with the media file. In response, the dynamically illuminated keys 802 can be configured to change with the output of the computing device 100. When audio is played at the computing device 100, the dynamically illuminated keys 802 can be arranged to resemble the frequency spectrum of the audio and change according to how the frequency spectrum of the audio changes over time. Additionally, in some embodiments, the computing device 100 includes a microphone that can receive an audio input from a user. The dynamically illuminated keys 802 can be configured to emulate the frequency response of the audio input of from a user. Moreover, if the user is communicating with someone else over the internet, the dynamically illuminated keys 802 can be configured to emulate the audio provided by both the user and a person or persons to whom the user is communicating.

The computing device 100 can incorporate a camera 106 which can be used to provide feedback for the illumination of the dynamically illuminated keys 802. The camera 106 can be internal to the computing device 100 or external to the computing device 100, and be arranged to receive images of the keyboard 104. The images can be used to accent certain portions of the keyboard 104 during operation of the keyboard 104 by a user. For example, the user may extend their hands over the keyboard 104, which can be recorded by the camera 106. The images received by the camera 106 can be converted into a digital format and sent to the circuit 400 in a way that causes the dynamically illuminated keys 802 to illuminate at locations where the user's hands are hovering above the keyboard. Additionally, dynamically illuminated keys 802 can be illuminated to outline the user's hands such that the LEDs 206 below the user's hands remain off or at a low brightness level, while the LEDs 206 surrounding the area immediately below the user's hand can be set at a high brightness level.

FIG. 8B illustrates an embodiment of a keyboard 104 having multiple backlights wherein only certain keys have been set to be illuminated according to some embodiments described herein. Specifically, FIG. 8B shows an embodiment wherein the keyboard 104 has been configured to display text associated with software running on the computing device 100. For example, in some embodiments, the computing device 100 can receive data from the internet and project the data over the internet responsive keys 804 of the keyboard 104. For example, if a user of the computing device is watching a movie (e.g., the movie PI, as shown in FIG. 8B), the movie title can be retrieved from the internet and projected over the internet responsive keys 804. Additionally, if the data that is pulled from the internet is too long to be projected on the keyboard 104 because there are not enough keys, the keyboard 104 can act as a scrolling display that can display text and scroll the text from left to right, right to left, up and down, diagonal, or any combination thereof. For example, if a user wishes to project a list of stock prices from an internet website, the ticker symbols and their respective prices can be projected across the keyboard 104 and be configured to move over the keyboard 104 at a certain rate specified by a user, website, or manufacturer of the computing device 100. In this way, the LEDs 206 associated with the internet response keys 804 will rapidly change in brightness over the period of time that the user wishes to use this function of the keyboard 104. In other embodiments, notifications from the computing device 100 can be displayed in a static or dynamic fashion, similar to FIGS. 7A-8B. For example, if a user of the computing device 100 receives a text message through the computing device 100, the LEDs 206 of the keyboard 104 can flash one or more times that signify the presence of a new text message. In some embodiments, the LEDs 206 can display the text of the message or the name of the messenger as a scrolling message that moves across the LEDs 206 of the keyboard 104. Moreover, an animation can be displayed by the LEDs 206 of the keyboard 104 according to some embodiments described herein. The animation can resemble any motion picture such as a screen saver that is displayed by the LEDs 206 when the computing device 100 has been idle for a specified period of time.

The embodiments described herein can include multi-colored LEDs 206 and mono-colored LEDs 206. For example, any of the embodiments described herein can incorporate red, green, and blue LEDs 206. In this way, any of the embodiments can be made more dynamic by the use of multiple colors. Additionally certain embodiments can be combined using different colors to distinguish one embodiment over another. For example, in some embodiments, a spell-checking application is combined with an address book application. In this way, when a user is typing text that resembles both misspelled word and the name of a contact in an address book, the remaining keys associated with the letters of the correctly-spelled word can be illuminated by red LEDs 206, while the remaining keys associated with the letters of the contact in the address book can be illuminated in green.

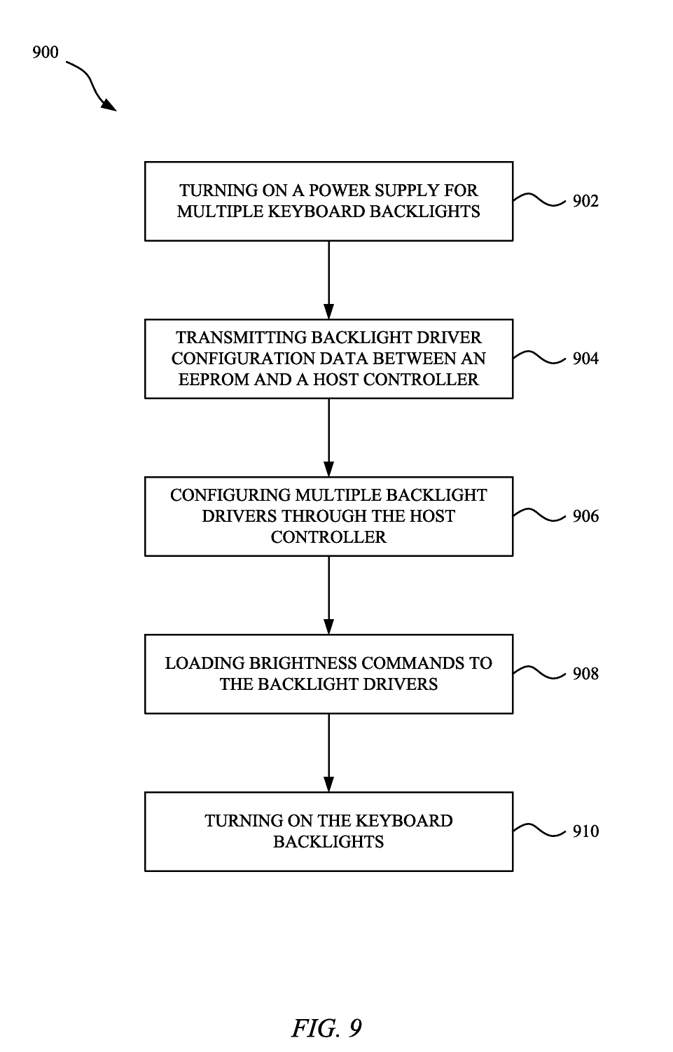

FIG. 9 illustrates a method 900 for operating a keyboard having multiple backlights (also referred to as LEDs). The method 900 includes a step 902 of turning on a power supply for the multiple backlights. This step 902 can include powering up one or more multiple power supplies, and applying power to one or more supply rails that extend across the interior of the keyboard. At step 904, configuration data is transmitted between an EEPROM and a host controller. The configuration data can include information obtained from a calibration of the keyboard backlights, or any other information data according to embodiments described herein. The method 900 can further include a step 906 of configuring multiple integrated circuits through the host controller. The step 906 can be performed using the configuration data transmitted between the EEPROM or other data transmitted from a computing device to which the keyboard can be configured to communicate. At step 908, the method 900 includes loading brightness commands to the integrated circuits. The brightness commands can be an initial startup configuration for the backlights, commands related to other software loaded onto the computing device, commands received from software external to the computing device, or any commands to accomplish the embodiments discussed herein. At step 910, one or more of the keyboard backlights are turned on in response to receiving a brightness command at one or more of the integrated circuits. The brightness commands can be commands to turn on and/or off certain backlights of individual keys of the keyboard, or adjust a brightness level of certain backlights of the individual keys of the keyboard.

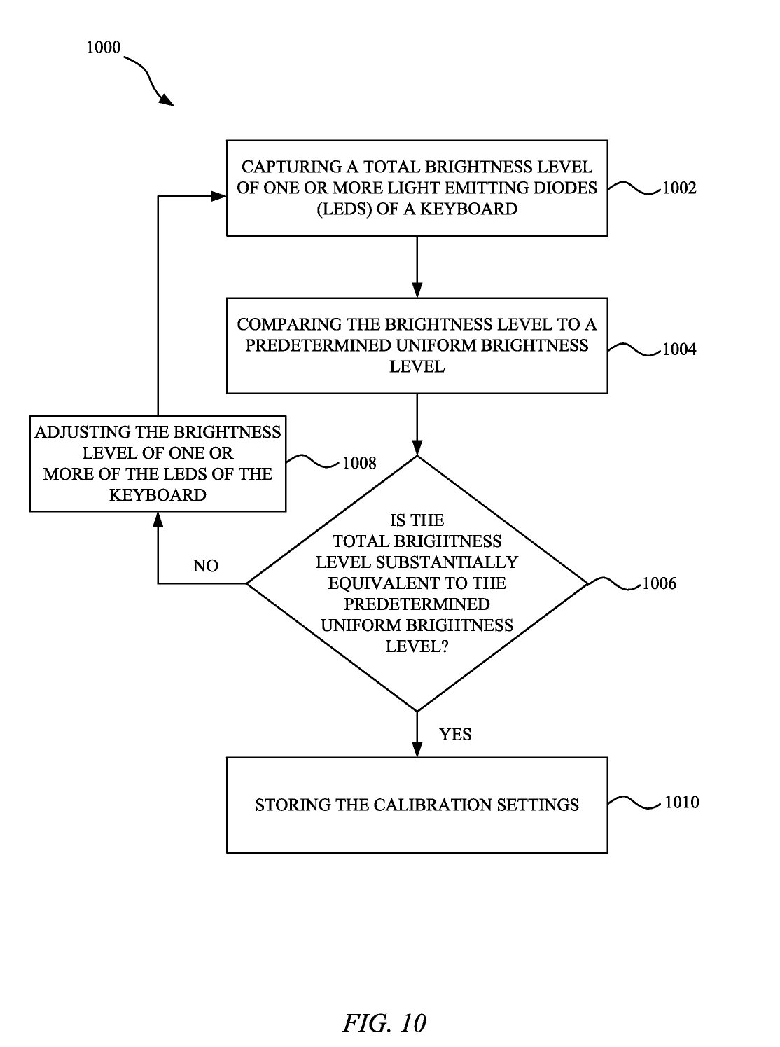

FIG. 10 illustrates a method 1000 for calibrating a keyboard having multiple backlights. The method 1000 includes a step 1002 of capturing a total brightness level of one or more light emitting diodes (LEDs) of a keyboard. The capturing can be performed by a camera according to some of the embodiments described herein. At step 1004, the method 1000 can include comparing the brightness level to a predetermined uniform brightness level. The predetermined uniform brightness level can correspond to a brightness level that allows the keyboard LEDs to be illuminated together in an apparent uniform fashion. The uniformity can be observed and measured from a distance away from the keyboard, or proximate to the keyboard. At step 1006, a determination is made as to whether the total brightness level is substantially equivalent to the predetermined uniform brightness level. If the total brightness level is substantially equivalent to the predetermined uniform brightness level, the method 1000 proceeds to a step 1010 of storing the configuration as calibration settings for the keyboard. If the total brightness level is not substantially equivalent to the predetermined uniform brightness level, the method 1000 proceeds to a step 1008 of adjusting the brightness level of one or more of the LEDs of the keyboard. After step 1008 is complete, the method 1000 returns to step 1002 where the method 1000 is continued for an additional iteration. The method 1000 can be repeated until the predetermined uniform brightness level is reached. Moreover, the method 1000 can be modified according to some embodiments described herein.

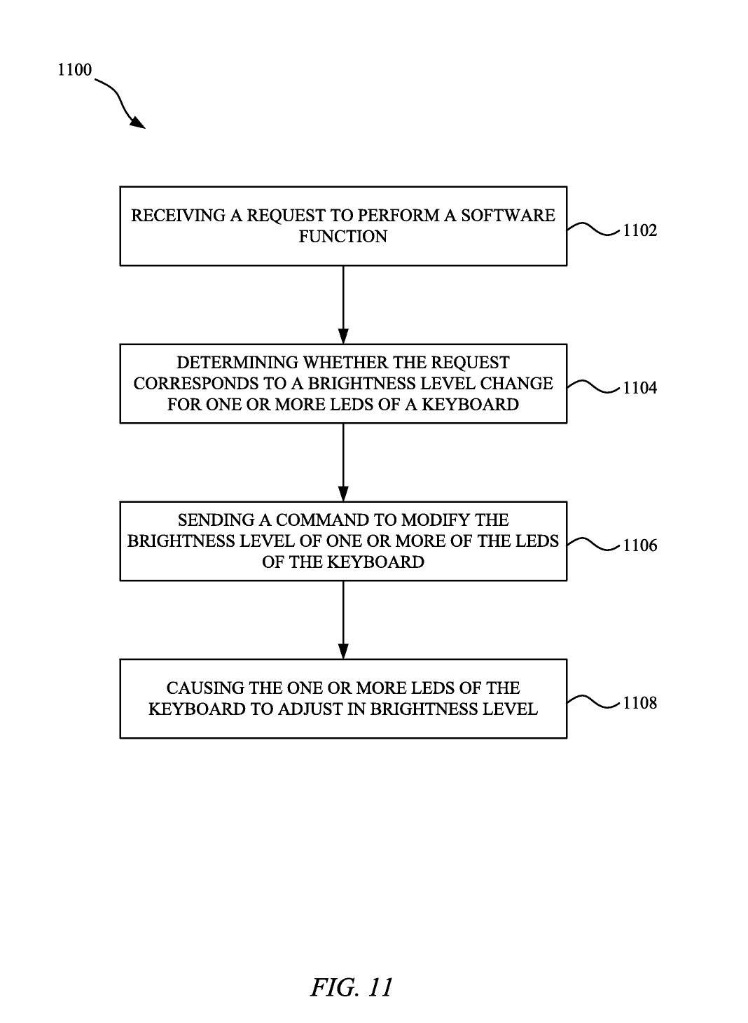

FIG. 11 illustrates a method 1100 for modifying the brightness level of one or more LEDs of a keyboard according to some embodiments described herein. The method 1100 includes a step 1102 of receiving a request to perform a software function. The request can be from a user or from an application associated with the computing device to which keyboard is configured to communicate. At step 1104, the computing device determines whether the request to perform a software function corresponds to a brightness level change for one or more LEDs of the keyboard. Step 1104 includes comparing the request to a table of commands that are associated with modifying the brightness level of one or more LEDs of the keyboard. For example, if a user initiates a shutdown procedure (i.e., a request), the computing device can determine whether the shutdown procedure is included in the table of commands and derive the modification that should be made to the brightness level of one or more of the LEDs. Upon determining that the brightness level of the one or more LEDs should be modified according to the request, the method 1100 proceeds to step 1106. At step 1106, a command is sent to the circuit controlling the LEDs to modify the brightness level of one or more of the LEDs of the keyboard. At step 1108, the computing device causes the one or more LEDs of the keyboard to adjust to a certain brightness level according to the sent command.

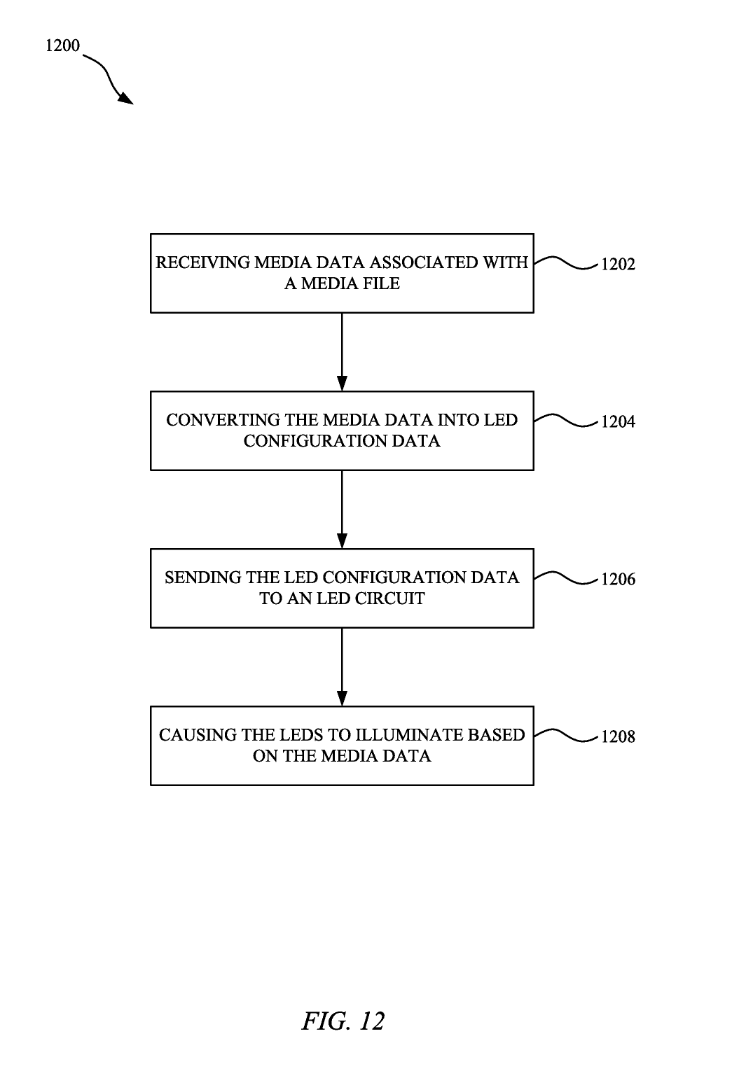

FIG. 12 illustrates a method 1200 for modifying the brightness level of one or more LEDs of a keyboard according media data associated with a media file. The method 1200 includes a step 1202 of receiving media data associated with a media file. The media data can be received from the internet or any other suitable source of media data. At step 1204, the media data is converted into LED configuration data. At step 1206, the LED configuration data is sent to a lighting circuit. As a result, at step 1208, the LEDs are caused to illuminate based on the media data. The method 1200 can be modified according to any of the embodiments described herein. For example, the method 1200 can be used to display data associated with video, music, or other files that a user is executing on a computing device associated with the keyboard.

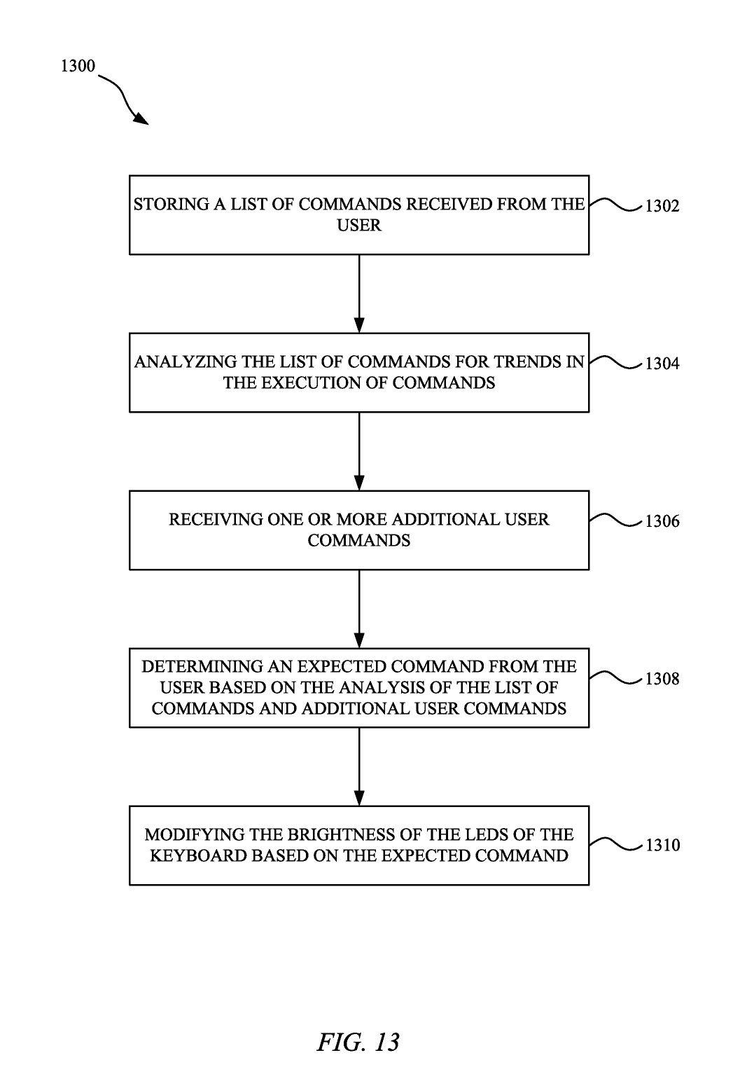

FIG. 13 illustrates a method 1300 for modifying the brightness level of one or more LEDs of a keyboard according an expected command from a user of the keyboard. The method can include a step 1302 of storing a list of commands received from the user. At step 1304, the list of commands can be analyzed for trends in the execution of the commands. For example, the order of commands can correspond to the spelling of the name of a contact in an address book stored on a computing device, or the remaining letters of a word that the user is typing. At step 1306, additional commands are received from a user after the list of commands has been analyzed. The additional commands are compared to the list of commands at step 1308 where an expected command is determined based on the analysis of the list of commands. At step 1310, the brightness of the LEDs are modified based on the expected command. In this way, the user is provided can be directed to depress certain keys according to an intelligent algorithm that can learn and adapt to the typing habits of the user.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A lighting circuit for a keyboard, comprising:
a plurality of light emitting diode (LED) drivers;
a host controller connected to the plurality of LED drivers;
a plurality of LEDs connected to the plurality of LED drivers, wherein each LED of the plurality of LEDs is configured to illuminate a key of the keyboard and, be responsive to an operation performed by a computing device associated with the keyboard; and
a memory connected to the host controller, wherein the memory stores calibration data associated with each brightness level of a plurality of brightness levels between which the plurality of LEDs can be transitioned.

2. The lighting circuit of claim 1, wherein the calibration data is configured to compensate for a difference in luminance that can be exhibited by at least two LEDs when operating a specific brightness level.

3. The lighting circuit of claim 1, wherein the difference in luminance results from structural differences between keys of the keyboard.

4. The lighting circuit of claim 1, wherein the plurality of LEDs include a first LED that is capable of providing a different color of light than a second LED of the plurality of LEDs.

5. The lighting circuit of claim 1, wherein the plurality of LEDs are capable of responding to a user input of a computing device such that when the keyboard is operatively coupled to the computing device, the plurality of LEDs are capable of receiving current based on the user input.

6. The lighting circuit of claim 1, further comprising an LED power supply connected to a plurality of supply rails that extend across a length of the keyboard and connect to the plurality of LEDs.

7. The lighting circuit of claim 1, wherein the plurality LED drivers are capable of supplying an individual current to each of the LEDs of the plurality of LEDs and the plurality of LEDs includes at least 24 LEDs.

8. A method for controlling brightness of light emitting diodes (LEDs) connected to a keyboard, the method comprising:
accessing calibration data that includes information associated with each brightness level of a plurality of brightness levels between which the LEDs can be transitioned;
sending a command to a lighting circuit for the keyboard, wherein the lighting circuit controls a brightness level of the LEDs according to the calibration data; and
causing the brightness of one or more LEDs of the LEDs to change.

9. The method of claim 8, further comprising:
causing a first LED and a second LED of the LEDs to receive different currents from one or more LED drivers of the lighting circuit.

10. The method of claim 8, further comprising:
receiving a software command from a software application on a computing device to which the keyboard is capable of communicating, wherein the software command is associated with a change in the brightness level of the one or more LEDs of the LEDs over a period of time.

11. The method of claim 8, wherein the calibration data is configured to compensate for a difference in luminance that can be exhibited by at least two of the LEDs operating according to a specific brightness level.

12. The method of claim 11, wherein the difference in luminance results from structural differences between keys of the keyboard.

13. The method of claim 8, wherein the change is based on a data file that is executed contemporaneously with the change in brightness of one or more of the LEDs.

14. A machine-readable non-transitory storage medium storing instructions that, when executed by a processor included in a computing device, cause the computing device to carry out steps that include:
accessing calibration data associated with each brightness level of a plurality of brightness levels between which a plurality of LEDs can be transitioned, wherein each LED of the plurality of LEDs is configured to individually illuminate a key of a keyboard;
sending a command to modify the plurality of light emitting diodes (LEDs) based on a predetermined configuration; and
causing a brightness level of one or more LEDs of the plurality of LEDs to change according to the predetermined configuration and the calibration data.

15. The machine-readable non-transitory storage medium of claim 14, wherein the predetermined configuration is a sequence of changes in the brightness level of the one or more LEDs over a predetermined period of time.

16. The machine-readable non-transitory storage medium of claim 14, wherein causing a brightness level of one or more LEDs of a plurality of LEDs to change includes displaying an animation using the plurality of LEDs.

17. The machine-readable non-transitory storage medium of claim 14, wherein the calibration data is configured to compensate for a difference in luminance that can be exhibited by at least two LEDs of the plurality of LEDs operating according to a specific brightness level.

18. The machine-readable non-transitory storage medium of claim 14, wherein the difference in luminance results from structural differences between keys of the keyboard.

19. The machine-readable non-transitory storage medium of claim 14, wherein the plurality of LEDs include at least 24 LEDs, wherein each LED of the at least 24 LEDs is capable of individually illuminating a key of the keyboard.

20. The machine-readable non-transitory storage medium of claim 14, further comprising:
storing data that associates each key of a plurality of keys of the keyboard with one or more LEDs of the plurality of LEDs.
